(19) United States
(12) Patent Application Publication
(10) Pub. No.: US 2026/0355643 A1
(43) Pub. Date: Nov. 12, 2026

(54) ARTICULATING SYSTEM

(71) Applicants: Michael LaPointe, Anchorage, AK (US); Dan Dyble, Powell River (CA)

(72) Inventors: Michael LaPointe, Anchorage, AK (US); Dan Dyble, Powell River (CA)

(21) Appl. No.: 19/121,171

(22) PCT Filed: Oct. 20, 2023
(86) PCT No.: PCT/US2023/035595

§ 371 Date: Apr. 15, 2025

Related U.S. Application Data
(60) Provisional application No. 63/418,470, filed on Oct. 21, 2022.

(51) Int. Cl. A63H 13/06; A63H 33/26

(52) U.S. Cl. CPC A63H 13/06; A63H 33/26

(57) ABSTRACT

The invention discloses an articulating system comprising two or more objects, one or more joining modules, a magnetic module, a power source and a processor module. Each object comprises one or more bobbling components, and the bobbling components are movably connected to the object by the joining module. The magnetic module comprises at least one first magnetic component and at least one second magnetic component. The first magnet is an electromagnet. The power source module is configured to supply power to the electromagnet. The processor module is configured to control the power source module to supply power to the magnetic module, to create a magnetic field that attracts the second magnetic component, thereby inducing movement to the bobbling components associated with the first and second magnetic components.

### CROSS-REFERENCE TO RELATED APPLICATION

The present application claims the benefit of U.S. provisional application 63/418,470 filed on 21 Oct. 2022 entitled “AN ELECTROMAGNET SYSTEM TO CONTROL MOVEMENT OF A BOBBLING COMPONENT IN BOBBLE DOLLS”, the contents of which are hereby incorporated by reference.

### TECHNICAL FIELD

The present invention relates generally to articulated objects. More specifically, the present invention is an articulating system to control movement of a bobbling component in bobble dolls.

### BACKGROUND

Generally, the articulated objects have one or more parts connected together and facilitates the relative movement of the connected parts. And such articulated objects are technologically important to several industries, business organizations and/or individuals. The benefits of articulated objects are different in each industry. The benefits of the articulated objects in toy industry are things like gifting, enjoyment, entertainment, decoration etc. In other industries including architecture and automotive vehicles, benefits of articulated objects may be vastly different, for example, benefits can include various forms of aesthetic and practical benefits.

At present there are different types of articulating objects available in the market. However, the conventional articulating objects are manually operated and lack customization in bobbling motion. For instance, in a conventional bobble toy, a manual interaction with the toy is required to move the bobbling component. As an example, this movement could be induced by placing one's hand on the bobbling component, moving the hand, and releasing it from the bobbling component.

Further, few existing patent applications attempt to address the problems or the technological gaps cited in the background as prior art over the presently disclosed subject matter and are explained as follows:

U.S. Pat. No. 9,827,504B2 assigned to Kenneth E. Olson, entitled “vibratory device for bobble toys” discloses a vibratory device for inducing movement to a bobble toy. The device comprises a base having magnetic members, a platform for supporting bobble toy having a bobble head, and springs to support the platform over the base. The device further comprises a control circuitry to activate and deactivate the magnetic members to induce a pattern of vibration to the bobble toy, and this vibration to the bobble toy causes the head of the toy to bobble. The device enables vibrations that are programmable, customizable, responsive to external input, and/or synchronized with other vibratory devices and accessories. The vibratory device includes a microphone or optical sensor for detecting sound, motion, and/or light. Further, the existing prior art requires some manual interactions for movement of the bobbling components.

Therefore, there is a need for an improved articulated system that overcomes the one or more of the above-mentioned limitations and gaps of the conventional bobbling apparatus and which require less human interaction and give customized movements to the user.

### SUMMARY

The present invention discloses an articulating system. The system comprises of two or more objects. Each object comprises of one or more bobbling components. The system further comprises of one or more joining modules. The joining module movably connect each bobbling component to the respective object. Further, the system comprises of a magnetic module. The magnetic module comprises of at least two magnetic components. The at least two magnetic component comprise a first magnetic component and a second magnetic component. The first magnetic component is an electromagnet.

The first magnetic component is disposed within one bobbling component, wherein the second magnetic component is disposed proximal to the first magnetic component and within at least one of the object respective of the bobbling component associated with the first magnetic component and another bobbling component of another object.

The system further comprises a power source module configured to supply power to the electromagnet. The system further comprises a processor module in communication with the power source module. The processor module is configured to control the power source module to supply power to the magnetic module. The power supply to the first magnetic component creates a magnetic field that attracts the second magnetic component, thereby inducing movement to the bobbling components associated with the first and second magnetic components.

In one embodiment, the bobbling component of one object is not directly attached to the bobbling component of another object. The processor module is configured to induce a brief collision via the magnetic module and enables the bobble component of each object to bobble independently.

In another embodiment, the two or more bobbling components of one or more objects are connected together. The two or more bobbling components are connected to at least one bobbling component associated with the magnetic component to enable movement of the connected bobbling components.

Further, the joining module comprises an elastic member. The joining module comprises one or more components selected from a group comprising, one or more magnets, one or more electromagnets, an electromechanical device, a spring, a conical spring, a leaf spring, a compression spring, a torsional spring, a garter spring, a hinge joint, a pivot joint, a prismatic joint, a ball-socket joint and a pointed shaft. Further, the second magnetic component comprises at least one of a ferromagnetic component, permanent magnet, the electromagnet, and a metal component.

Further, the processor module is configured to control supply of power to the magnetic module such that a first polarity of the first magnetic component is opposite to a second polarity of the second magnetic component. The processor further is configured to intermittingly alter the first polarity and the second polarity by the supply of electrical power to generate at least one of an attraction force and a repulsion force between the first magnetic component and the second magnetic component. The attraction and repulsion of the magnetic components induce a sequence of movements to the bobbling components.

The processor module further is configured to control a duration of the sequence of movement of the bobbling component. The system, further comprises one or more actuators in communication with the processor module and the magnetic module. The actuator is configured to control the polarity and magnetic field associated with the magnetic components.

The system further comprises a storage module in communication with the processor module. The storage module stores user information comprising one or more characteristics of one or more user, bobble sequence information comprising one or more bobble sequences and one or more bobble sequences for each user, one or more audios, one or more light patterns, and one or more audios and light patterns and one or more audios and light patterns for each user, the characteristics includes sound data, image data, movement data for each user.

In another embodiment, the system comprises one or more sensors in communication with the processor module. The sensor is configured to detect one or more characteristics of a user proximal to the objects. The processor is configured to control the power supply to enable the bobbling components to move in at least one sequence of movement corresponding to the user.

The system further comprises one or more output devices in communication with the processor module. The output devices comprise an audio device and a light source device. The processor is further configured to control the audio device to emit audio, control the light source device to emit light of one or more wavelengths, control the audio device to emit an audio corresponding to the user proximal to the objects and control the light source device to emit a light pattern corresponding to the user proximal to the objects.

The system further comprises a computing device in communication with the storage device, the processor module and the communication module via a network. The computing device comprises a memory storing one or more program modules and a processor configured to execute the program modules. The computing device is configured to control the output device to emit light of one or more wavelengths and emit audio, and control the sequence of movement of the bobbling component. The computing device is configured to control the bobbling component to move in a desired sequence of movement, control the audio device to play a desired audio control the light device to emit a desired light pattern and control a duration of the sequence of movement of the bobbling component.

The system further comprises a user device in communication with the computing device via the network. The computing device is configured to receive one or more input data from the user device to execute the program modules to control the objects.

The above summary contains simplifications, succinctness, generalizations, and omissions of detail and is not intended as a comprehensive description of the claimed subject matter but, rather, is intended to provide a brief overview of some of the functionality associated with the claimed subject matter. Other systems, methods, functionality, features, and advantages of the claimed subject matter will be or will become apparent to one with the skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are magnified relative to other elements. Embodiments incorporating teachings of the present disclosure are shown and described with respect to the figures presented herein, in which:

FIG. 1 exemplarily illustrates an articulating system comprising two human figures performing boxing, according to yet another embodiment of the present invention.

FIG. 2 exemplarily illustrates an articulating system of FIG. 1, where the bobbling components are attached to each other, according to yet another embodiment of the present invention.

FIG. 3 exemplarily illustrates an articulating system comprising a magnetic module attached to one bobbling component, according to yet another embodiment of the present invention.

FIG. 4 exemplarily illustrates an articulating system comprising a magnetic module attached to another bobbling component, according to yet another embodiment of the present invention.

FIG. 5 exemplarily illustrates an articulating system comprising a magnetic module attached to each bobbling component, according to yet another embodiment of the present invention.

FIG. 6 exemplarily illustrates a computer-implemented network environment for controlling the movement of a bobbling component, according to one embodiment of the present invention.

FIG. 7 exemplarily illustrates a block diagram of a system for facilitating automatic bobbling of at least one bobbling component, according to one embodiment of the present invention.

FIG. 8 exemplarily illustrates a computing device of FIG. 6, according to one embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as explanatory and not restrictive.

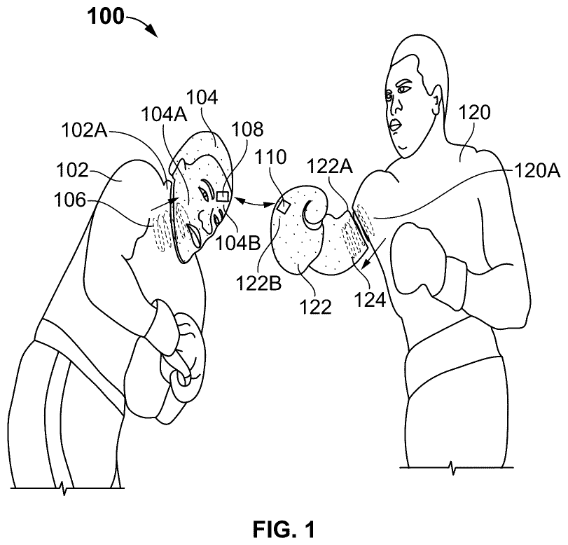

Referring to FIG. 1 to FIG. 5, the system (100, 200, 300, 400, 500) comprises two or more objects (102, 120). Each object (102, 120) comprises one or more bobbling components (104, 122). The two or more objects (102, 120) comprise a first object 102 and a second object 120. The first object 102 comprises one or more first bobbling components 104. In one embodiment, the first object 102 comprises at least one first bobbling component 104. The second object 120 comprises one or more second bobbling components 122. In one embodiment, the second object 120 comprises at least one second bobbling component 122.

The system (100, 200, 300, 400, 500) further comprises one or more joining modules (106, 124). The joining modules (106, 124) enable movement of the bobbling components (104, 122) that are connected to the respective objects (102, 120). In one embodiment, each joining module (106, 124) comprise one or more components selected from a group comprising, a coil, a spring, a conical spring, a leaf spring, a compression spring, a torsional spring, a garter spring, a hinge joint, a pivot joint, a prismatic joint, a ball-socket joint, a mechanism having a hook and loop component, a conical component or a component balanced on a post, and an electromechanical device. The joining modules (106, 124) comprise one or more first joining modules 106 and one or more second joining modules 124. In one embodiment, the joining modules (106, 124) comprise a first joining module 106 and a second joining module 124. The at least one first bobbling component 104 is attached to the first object 102 via the first joining module 106 and the at least one second bobbling component 122 is attached to the second object 120 via the second joining module 124.

The first joining module 106 is embedded or hidden inside the first object 102. The at least one first bobbling component 104 comprises a first end 104A and a second end 104B. In one embodiment, the first joining module 106 is disposed between a first end 102A of the first object 102 and the first end 104A of the at least one first bobbling component 104. In one embodiment, the first joining module 106 is mechanically connected to the first end 102A of the first object 102. In one embodiment, the first joining module 106 is mechanically connected to the first end 104A of the at least one first bobbling component 104. In one embodiment, the first joining module 106 is configured to bobble the at least one first bobbling component 102 in any desired direction of motion. The direction of motion includes an axis of motion.

The second joining module 124 is embedded or hidden inside the second object 120. The at least one second bobbling component 122 comprises a first end 122A and a second end 122B. In one embodiment, the second joining module 124 is disposed between a first end 120A of the second object 120 and the first end 122A of the at least one second bobbling component 122. In one embodiment, the second joining module 124 is mechanically connected to the first end 120A of the second object 120. In one embodiment, the second joining module 124 is mechanically connected to the first end 122A of the at least one second bobbling component 122. In one embodiment, the second joining module 124 is configured to bobble the at least one second bobbling component 122 in any desired direction of motion. The direction of motion includes an axis of motion.

The system (100, 200, 300, 400, 500) further comprises a magnetic module. The magnetic module is embedded in the system (100, 200, 300, 400, 500). The magnetic module comprises at least two magnetic components (108, 110). The at least two magnetic components include a first magnetic component 108 and a second magnetic component 110.

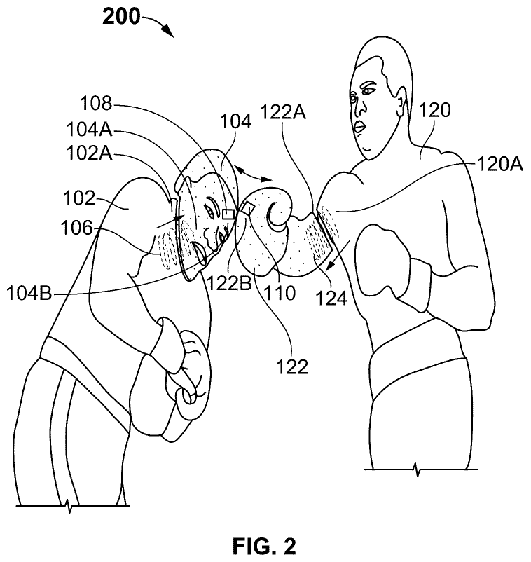

Referring to FIG. 1 to FIG. 2, the first magnetic component 108 is attached to the second end 104B of the at least one first bobbling component 104. The second magnetic component 110 is attached to the second end 122B of the at least one second bobbling component 122. The first joining module 106, the second joining module 124, and the connected at least two bobbling components (104, 122) enables the bobbling components (104, 122) to synergistically bobble in unison.

Referring to FIG. 1, the first bobbling component 104 is separated from the second bobbling component 122. Referring to FIG. 2, the first bobbling component 104 is connected to the second bobbling component 122. In one embodiment, the first bobbling component 104 is detachably connected to the second bobbling component 122 via the magnetic components (108, 110).

Referring to FIG. 1 and FIG. 2, the system (100, 200) comprises two or more objects including a first object 102 and a second object 120. The first object 102 is a first human figure and the second object 120 is a second human figure. In one embodiment, the first bobbling component 104 is a head connected to the first human figure via the first joining module 106. In one embodiment, the second bobbling component 122 is a limb connected the second human figure via the second joining module 124. The first end 104A of the first bobbling component 104 is connected to the first end 102A of the first object 102 via the first joining module 106. The first end 122A of the second bobbling component 122 is connected the first end 120A of the second object 120 via the second joining module 124.

In one embodiment, the at least one first bobbling component 104 is attached to the at least one second bobbling component 122 using the attached magnetic components (108, 110). In one embodiment, the magnetic components (108, 110) are configured to bobble the at least one first bobbling component 104 and the at least one second bobbling component 122 in any desired direction of motion. The desired direction of motion includes an axis of motion.

In one embodiment, the at least one first bobbling component 104 is attracted to the at least one second bobbling component 122 due to opposite polarities of the first magnetic component 108 and the second magnetic component 110. In one embodiment, the at least one first bobbling component 104 may be repelled away from the at least one second bobbling component 122 upon reversing of the polarities of the first magnetic component 108 and the second magnetic component 110.

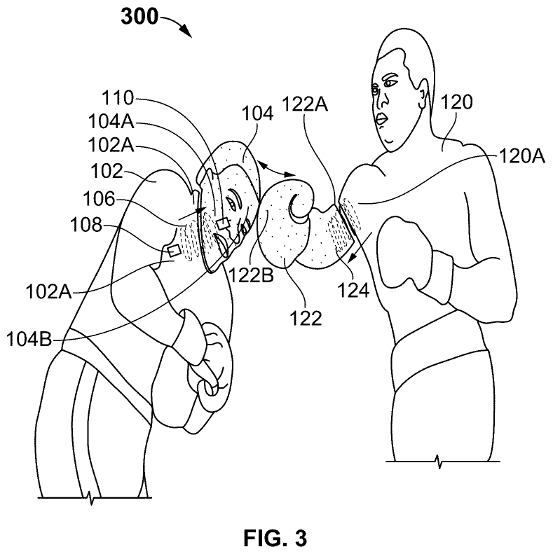

Referring to FIG. 3, the system 300 comprises two or more objects (102, 120). The two or more objects (102, 120) comprise a first object 102 and a second object 120. The first object 102 is a first human figure and the second object 120 is a second human figure. Each object (102, 120) comprises one or more bobbling components. The first object 102 comprises at least one first bobbling component 104. The second object 120 comprises at least one second bobbling component 122. The at least one first bobbling component 104 may be physically attached to the at least one second bobbling component 122. Further, the at least one first bobbling component 104 may bobble synergistically in unison with the at least one second bobbling component 122.

In one embodiment, the at least one first bobbling component 104 is connected to the first object 102 using a first joining module 106. Further, the first joining module 106 may be embedded or hidden inside the first object 102. In one embodiment, the first joining module 106 may be disposed between a first end 104A of the at least one first bobbling component 104 and a first end 102A of the first object 102. In one embodiment, the first joining mechanism 106 may be mechanically connected with the first end 104A of the at least one first bobbling component 104 and the first end 102A of the first object 102.

Further, the first joining module 106 is configured to bobble the at least one first bobbling component 104 in a desired direction of motion. The desired direction of motion includes an axis of motion. In some embodiments, the first joining module 106 may include, but not limited to, a pointed shaft, a prismatic joint, a conical spring, a leaf spring, a compression spring, a torsional spring, a garter spring, a spring, a coil, and a mechanism having hook and loop component, a conical component, or a component balanced on a post. The mechanism enables a hollow interior of the bobbling component (104, 122) to balance on a pointed stick of the object, which enables the bobbling component (104, 122) to oscillate relative to the pointed stick.

In one embodiment, the at least one second bobbling component 122 may be connected to the second object 120 using a second joining module 124. The second joining module 124 may be embedded or hidden inside the second object 120. In one embodiment, the second joining module 124 may be disposed between a first end 122A of the at least one second bobbling component 122 and a first end 120A of the second object 120. In one embodiment, the second joining module 124 may be mechanically connected with the first end 122A of the at least one second bobbling component 122 and the first end 120A of the second object 120.

Further, the second joining module 124 is configured to bobble the at least one second bobbling component 122 in a desired direction of motion. The desired direction of motion includes an axis of motion. In some embodiments, the second joining module 124 may include, but not limited to, one or more of a conical spring, a leaf spring, a pointed shaft, a compression spring, a torsional spring, a garter spring, a spring, a coil, and a mechanism having hook and loop component, a conical component, or a component balanced on a post. The mechanism enables a hollow interior of the bobbling component (104, 122) to balance on a pointed stick of the object, which enables the bobbling component (104, 122) to oscillate relative to the pointed stick.

The at least one first bobbling component 104 is detachably attached to the at least one second bobbling component 122 via one or more connecting modules. In one embodiment, a second end 104B of the at least one first bobbling component 104 is attached to a second end 122B of the at least one second bobbling component 122 using via one or more connecting modules. The connecting modules comprises one or more components selected from a group comprising one or more magnets, one or more electromagnets, a Velcro® fastener, an adhesive material, a snap fastener, a reusable bonding material, a reusable tape and suction cups.

In one embodiment, the system 300 comprises a magnetic module. In an embodiment, the magnetic module comprises a first magnetic component 108 and a second magnetic component 110. The magnetic components (108, 110) are disposed between the first end 102A of the first object 102 and the first end 104A of the at least one first bobbling mechanism 104. In one embodiment, the first magnetic component 108 is disposed at the first end 102A of the first object 102 proximal to one end of the first joining module 106. In one embodiment, the second magnetic component 110 is disposed at the first end 104A of the at least one first bobbling component 104 proximal to another end of the first joining module 106. In one embodiment, the magnetic module is configured to bobble the at least one first bobbling component 104 and the at least one second bobbling component 122 in a desired direction of motion. The desired direction of motion includes an axis of motion.

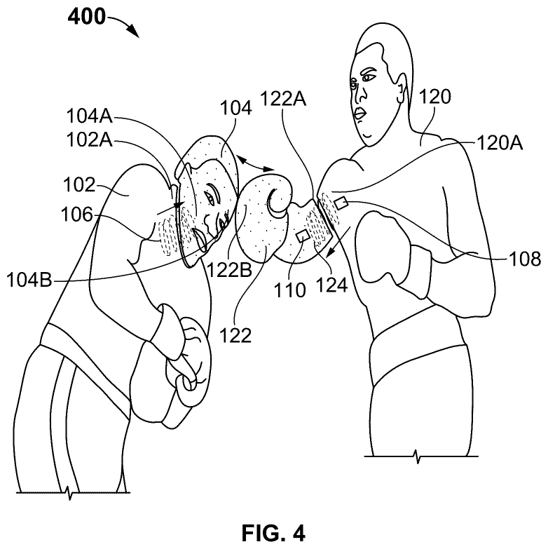

Referring to FIG. 4, the system 400 comprises two or more objects (102, 120). The two or more objects (102, 120) comprise a first object 102 and a second object 120. The first object 102 is a first human figure and the second object 120 is a second human figure. Each object (102, 120) comprises one or more bobbling components. The first object 102 comprises at least one first bobbling component 104. The second object 120 comprises at least one second bobbling component 122.

The at least one first bobbling component 104 is a first bobbling limb. The at least one second bobbling component 122 is a second bobbling limb. The at least one first bobbling component 104 is removably attached to the at least one second bobbling component 122. The at least one first bobbling component 104 may be physically attached to the at least one second bobbling component 122. Further, the at least one first bobbling component 104 may bobble synergistically in unison with the at least one second bobbling component 122.

In one embodiment, the at least one first bobbling component 104 is connected to the first object 102 using a first joining module 106. Further, the first joining module 106 may be embedded or hidden inside the first object 102. In one embodiment, the first joining module 106 may be disposed between a first end 104A of the at least one first bobbling component 104 and a first end 102A of the first object 102. In one embodiment, the first joining module 106 may be mechanically connected with the first end 104A of the at least one first bobbling component 104 and the first end 102A of the first object 102.

Further, the first joining module 106 is configured to bobble the at least one first bobbling component 104 in a desired direction of motion. The desired direction of motion includes an axis of motion. Further, the first joining module 106 may include, but not limited to, a conical spring, a leaf spring, a compression spring, a torsional spring, a garter spring, a spring, a coil, and a mechanism having hook and loop component, a conical component, or a component balanced on a post.

Further, the second joining module 124 is configured to bobble the at least one second bobbling component 122 in a desired direction of motion. The desired direction of motion includes an axis of motion. Further, the second joining module 106 may include, but not limited to, a conical spring, a leaf spring, a compression spring, a torsional spring, a garter spring, a spring, a coil, and a mechanism having hook and loop component, a conical component, or a component balanced on a post.

Further, the system 400 comprises a magnetic module. In an embodiment, the magnetic module comprises a first magnetic component 108 and a second magnetic component 110. The magnetic components (108, 110) are disposed between the first end 120A of the second object 120 and the first end 122A of the at least one second bobbling component 122. In one embodiment, the first magnetic component 108 is disposed at the first end 120A of the second object 120 proximal to one end of the second joining module 124. In one embodiment, the second magnetic component 110 is disposed at the first end 122A of the at least one second bobbling component 122 proximal to another end of the second joining module 124. In one embodiment, the magnetic module is configured to bobble the at least one second bobbling component 122 and the at least one first bobbling component 104 in a desired direction of motion. The desired direction of motion includes an axis of motion.

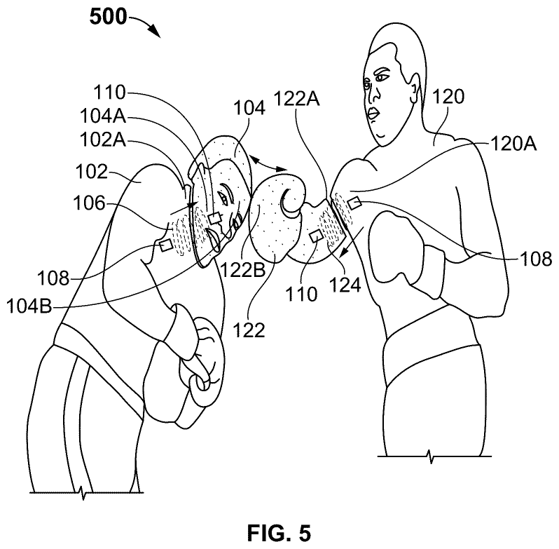

Referring to FIG. 5, the system 500 comprises one or more magnetic modules. In an embodiment, each magnetic module comprises a pair of magnetic components. Each pair of magnetic components includes a first magnetic component 108 and a second magnetic component 110. The first pair of magnetic components (108, 110) are disposed between the first end 102A of the first object 102 and the first end 104A of the at least one first bobbling component 104. The second pair of magnetic components (108, 110) are disposed between the first end 120A of the second object 120 and the first end 122A of the at least one second bobbling component 122.

In one embodiment, the first magnetic component 108 of the first pair of magnetic component is disposed at the first end 102A of the first object 102 proximal to one end of the first joining module 106. In one embodiment, the second magnetic component 110 of the first pair of magnetic component is disposed at the first end 104A of the at least one first bobbling component 104 proximal to another end of the first joining module 106. In one embodiment, the first pair of magnetic components (108, 110) are configured to bobble the at least one first bobbling component 104 and the at least one second bobbling component 122 in a desired direction of motion. The desired direction of motion includes an axis of motion.

In one embodiment, the first magnetic component 108 is disposed at the first end 120A of the second object 120 proximal to one end of the second joining module 124. In one embodiment, the second magnetic component 110 is disposed at the first end 122A of the at least one second bobbling component 122 proximal to another end of the second joining module 124. In one embodiment, the magnetic module is configured to bobble the at least one second bobbling component 122 and the at least one first bobbling component 104 in a desired direction of motion. The desired direction of motion includes an axis of motion.

Referring to FIG. 1 to FIG. 5, each system (100, 200, 300, 400, 500) comprises the magnetic components (108, 110). In some embodiments, the magnetic components (108, 110) may include many configurations of materials that can be used, for example, one or more electromagnets and one or more metal objects, one or more electromagnets and one or more ordinary magnets, and two or more electromagnets. Further, any of the configurations may be embedded into any type of bobbling apparatus during production or integrated into any type of existing bobble doll in an aftermarket retrofit system.

Further, the first magnetic component 108 and the second magnetic component 110 are integrated into any type of existing bobble doll as an aftermarket retrofit kit to make the existing bobble doll bobble. In an instance, the first magnetic component 108 may be an electromagnet and the second magnetic component 110 may be a metallic object such as an armature plate. In another instance, the first magnetic component 108 may be an electromagnet and the second magnetic component 110 may be a second electromagnet or ordinary magnet.

Further, the magnetic module is configured to perform at least one of repelling and attracting the first magnetic component 108 towards the second magnetic component 110 based on at least one command. Alternatively, the magnetic module may be cycled between power off and power on. This may cause the two ends of the two or more components to alternate between being attracted to each other, and not being attracted to each other.

In one embodiment, the magnetic components (108, 110) may include at least one electromagnet and at least one ordinary magnet. In one embodiment, the magnetic components (108, 110) may include at least one electromagnet and at least one piece of ferromagnetic metal. The magnetic components (108, 110) are configured to produce bobbling in any type of the bobble doll on-demand. When powered, by continuously reversing the polarity of the electromagnet, and with an ordinary magnet also employed, for example, at the other end of the spring or coil, the two or more bobbling components (104, 122) may be attracted-repelled, attracted, repelled, attracted-repelled so and so forth (for as many number of times).

In another embodiment, the magnetic components (108, 110) may be cycled between power off and power on. This may cause the two ends of the bobbling components (104, 122) to alternate between being attracted to each other, and not being attracted to each other. When the two or more magnets or one or more magnets or one or more pieces of ferromagnetic metal attract each other, the joining modules (106, 122) may be compressed. When the two or more magnets repel each other, the joining modules (106, 122) may be decompressed. In one embodiment, the compressing and decompressing of the joining modules (106, 122) may initiate and/or sustain the bobbling of the at least one bobbling component (102, 120).

The magnetic module produces a bobble in any type of the bobble doll on-demand. In one embodiment, the magnetic module is embedded in the disclosed bobbling apparatus. Further, when powered, by continuously reversing the polarity of the electromagnet and with an ordinary magnet also employed (for example at the other end of the spring or coil), the magnetic components (or two or more magnets) (108, 110) may be attracted, repelled, attracted, repelled, etc. In another embodiment, the magnetic component may be cycled between power off and power on. This may cause the two ends (of the two or more components) to alternate between being attracted to each other, and not being attracted to each other. Further, when the two or more magnetic components (108, 110) attract each other, the joining modules (106, 124) may be expanded. Further, when the two or more magnetic components (108, 110) repel each other, the joining modules (106, 124) may be compressed. Further, the expansion and compression of the joining modules (106, 124) may initiate and/or sustain the bobbling of the at least one bobbling component. In one embodiment, the system (100, 200, 300, 400, 500) enables movement of at least one first bobbling component and the at least one second bobbling component 122 using an electromechanical device. The electromechanical device includes, but is not limited to, electric motor, solenoid, or electromagnet, and others.

The system (100, 200, 300, 400, 500) further comprises a power source module having multiple batteries. The magnetic components (108, 110) are battery-powered using various types of batteries comprised in the system (100, 200). The power source module is embedded into the system (100, 200). The power source module comprises one or more batteries. In one embodiment, the batteries are replaceable. The batteries may be recharged using solar power or other types of power capable of recharging the battery. The magnetic module may use line voltage. In one embodiment, the magnetic module may be programmable in a variety of ways. For example, the magnetic module may be set to cause bobbling for X seconds or minutes bobble, every X seconds or minutes.

The system (100, 200, 300, 400, 500) further comprises at least one sensor. The at least one sensor may include, but not limited to, an image sensor, an audio sensor, and motion sensor. The at least one sensor is configured to generate at least one sensor data based on detecting at least one image, at least one sound, etc.

The system (100, 200, 300, 400, 500) further comprises at least one actuator module including a first actuator and a second actuator. The first actuator is mechanically coupled with the first joining module 106. The second actuator is mechanically coupled with the second joining module 124. In one embodiment, the first actuator is configured to control a movement/motion of the first joining module 106. In one embodiment, the second actuator is configured for controlling a movement/motion of the second joining module 124. The actuator may include, but not limited to, a rotary actuator, a mechanical actuator, an electric actuator, etc.

The system (100, 200, 300, 400, 500) further comprises a communication device. The communication device is communicatively coupled with the at least one actuator module and the at least one sensor. In one embodiment, the communication device is configured to receive the sensor data from the at least one sensor.

The system (100, 200, 300, 400, 500) further comprises a processing device. The processing device is communicatively coupled with the communication device. The processing device is configured to analyze the at least one sensor data. The processing device is configured to generate the at least one command based on the analyzing. Further, the communication device is configured for transmitting the at least one command to at least one of the first actuator, the second actuator, and the magnetic modules. In some embodiments, the communication device is configured for transmitting the at least one command and the at least one sensor data to at least one user device associated with a user. Further, the at least one user device may include, but not limited to, a smartphone, a mobile, a tablet, a personal computer, a laptop, or any other suitable electronic communication device.

In one embodiment, the at least one user device comprises the at least one sensor. In some embodiments, the at least one sensor may include a motion sensor for determining a person approaching the system (100, 200). Further, the processing device is configured for identifying the person approaching the system.

The system (100, 200, 300, 400, 500) further comprises a storage device. The storage device is communicatively coupled with the communication device. In one embodiment, the storage device is configured to retrieve a bobble sequence information based on the identifying. Based on the bobble sequence information, the at least one command is generated. Further, when a person approaches the object, the system (100, 200) may start a pre-programmed bobble sequence.

In one embodiment, the system (100, 200, 300, 400, 500) wirelessly communicates with a software platform. The software platform may be application software, mobile application, web-based application, or desktop application. The communication device is configured for receiving a bobbling selection from the at least one user device. The storage device is configured for retrieving a bobbling data corresponding to the bobbling selection. The at least one command is generated based on the bobbling data. Further, the bobbling data includes a sequence or pattern of bobbling of the system (100, 200) in various ways including, but not limiting to, on-demand bobbling, bobbling with a selectable range of bobbling motion from mild to severe, duration of bobbling, and many others.

In some embodiments, the system (100, 200, 300, 400, 500) comprises at least one additional output device. The output device may be, but not limited to, a speaker, a light source, etc. In one embodiment, the bobbling data may include an additional data corresponding to the at least one additional output device. Further, the additional data may indicate that at least one user may want to produce output using the at least one additional output device. In one embodiment, the processing device is configured for generating an output command associated with the at least one additional output device based on the additional data. The communication device is configured for transmitting the output command to the at least one additional output device. The at least one additional output device is configured for generating an output based on the output command. For instance, the speaker is configured for generating a sound based on the output command. In another instance, the light source is configured for producing light based on the output command. The at least one additional output device produces the output in synchronization with the bobbling of the system.

In addition, other types of effects can be integrated and coordinated with the bobbling effect. For example, the smartphone application (or app) may play, before, during and/or after the bobbling, an audio. The audio may include voice notes by the user and music. The music may include an album music, personalized music, etc. Further, the music may be associated with a genre.

In one embodiment, the at least one sensor includes an audio sensor configured for generating the at least one sensor data based on detecting the audio. The system (100, 200) bobbles in tune with the audio based on the at least one command. This may be used with the magnetic module and other mechanisms that cause bobbling without manual intervention. Further, the bobbling of the system (100, 200) is coordinated with additional features of the system, such as the coordination of the bobbling motion with audio effects. These effects may include music, words, etc. The app may enable the user to select from a menu of audio effects, to record their own effect, etc.

Further, an example may be considered to describe the BobbleBattle design. The at least one first bobbling component 104 of the first object 102 and the at least one second bobbling component 122 of the second object 120 are separated by a small amount. Further, in an instance, the first object 102 represents a design of a boxer A having the at least one first bobbling component 104 comprising a head and the second object 120 represents a design of a boxer B having at least one second bobbling component 122 comprising a right arm.

Further, the glove part of B's bobbling component is close to, but not touching, the head, A's bobbling component. The magnetic components (108, 110) may be integrated into the glove of B and the head of A. When the magnetic module is powered on by the push of a button, use of a smart device app, etc., the magnetic components (108, 110) causes the glove of B to be attracted to the head of A. This causes an impact between the glove and the head. The magnetic components (108, 110) is then quickly powered off. This terminates the attraction between the glove and the head, and they are separated. As a result, the two bobbling components (the arm and the head) (104, 122) may bobble, but independently, not together as in conventional designs. Further, upon impact, the audio may mimic the sound of a punch landing, the grunt of a boxer, the cheer of the crowd, etc. Further, “kits” may be designed and used to swap different main objects, for example, different celebrities, superheroes, politicians, etc., may be swapped into and out of the boxer design.

Referring to FIG. 1 to FIG. 5, the magnetic modules are integrated directly into the bobbling components (104, 122), and directly induces bobbling of the bobbling components (104, 122). Further, the bobbling component 104 of one object 102 is not directly attached to the bobbling component 122 of another object 120. The processor module is configured to induce a brief collision via the magnetic module and enables the bobbling components (104, 122) of each object (102, 120) to bobble independently.

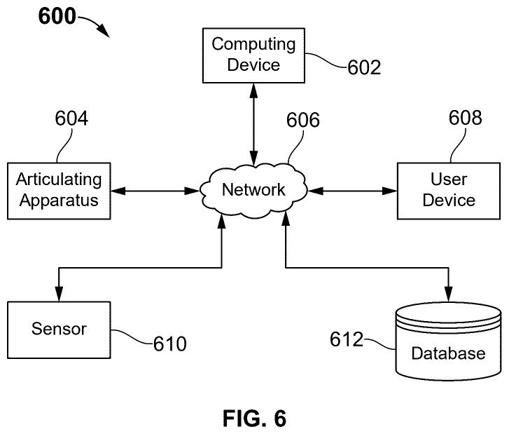

Referring to FIG. 6, a system 600 comprises the articulating apparatus 604, a computing device 602 in communication with the articulating apparatus 604, one or more user devices 608 in communication with the computing device 602 at least one database 612 and one or more sensors 610. The user device 608, the articulating apparatus 604 and sensors 610 are in communication with the computing device 602 via a network 606. Each system (100 to 500) comprising two or more objects (102, 120) comprising one or more bobbling components (104, 112, 122) are also referred as an articulating apparatus 604.

The computing device 602 comprises one or more processors and one or more memories. The processor is configured to execute one or more program modules. The computing device 602 is configured to control movement of the bobble components. In one embodiment, the computing device 602 is configured to automatically induce the movement of the bobble components (104, 112, 122). In one embodiment, the computing device 602 is a server. In another embodiment, the computing device 602 is a cloud server.

In yet another embodiment, the computing device 602 is at least one of a general or special purpose computer. In an embodiment, computing device 602 operates as a single computer, which can be a hardware and/or software server, a workstation, a desktop, a laptop, a tablet, a mobile phone, a mainframe, a supercomputer, a server farm, and so forth. In an embodiment, the computer could be touchscreen and/or non-touchscreen device and could run on any type of OS, such as iOS™, Windows™, Android™, Unix™, Linux™ and/or others. In an embodiment, the computing device 602 is in communication with the user device 608 via a software application, a mobile app, a browser, an OS, and/or any combination thereof. The user device 608 is associated with a user. The user device 608 is configured to enable the user to control the apparatus.

The user device 608 is a computing device 602 configured to provide access to the service provided by the server. The user device 608 is configured to provide an interface to access the services provided by the server.

The interface, for example, is an application that allows the user device 608 to wirelessly connect with the computing device 602 via the network 606. The user device 608 includes, but not limited to, a desktop computer, a laptop computer, a mobile phone, a personal digital assistant, and the like. The user device 608 is configured to execute one or more client applications such as, without limitation, a web browser to access and view content over the network 606, a File Transfer Protocol (FTP) client for file transfer. The user device 608 in various embodiments, may include a Wireless Application Protocol (WAP) browser or other wireless or mobile device protocol suites.

The network 606 generally represents one or more interconnected networks 606, over which the user device 608 and the server can communicate with each other. The network 606 may include packet-based wide area networks (such as the Internet), local area networks (LAN), private networks, wireless networks, satellite network, cellular networks, paging networks, and the like. A person skilled in the art will recognize that the network 606 may also be a combination of more than one type of network 606. For example, the network 606 may be a combination of a LAN and the Internet. In addition, the network 606 may be implemented as a wired network, a wireless network or a combination thereof.

In an embodiment, the database 612 is accessible by the computing device 602. In another embodiment, the database 612 may be integrated into the server or separate from it. In an embodiment, at least one database 612 resides in the computing device 602 or in a cloud computing service. In an embodiment, regardless of location, the database 612 comprises a memory to store and organize data for use by the server.

The database 612 stores user information comprising one or more characteristics of one or more user, bobble sequence information comprising one or more bobble sequences and one or more bobble sequences for each user, one or more audios, one or more light pattern, and one or more audios and light pattern for each user. The characteristics include, but not limited to, sound data, image data, movement data of the user. one or more audios include, but not limited to, voice notes and music. one or more light pattern includes, but not limited to, flashing of light and flashing of light in a sequence, flashing of light of different wavelength.

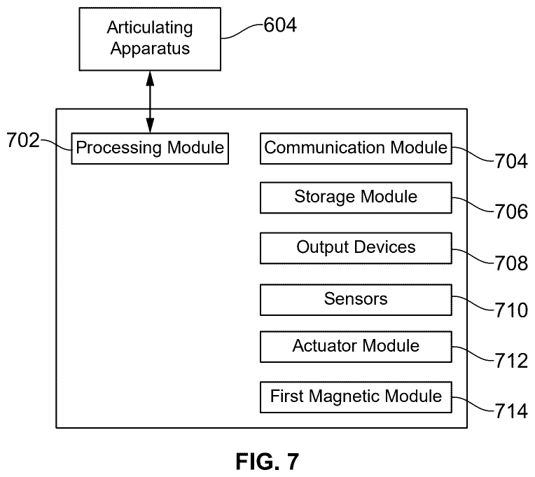

Referring to FIG. 7, the system comprises a processor module 702, a storage module 706 in communication with the processor module 702, a communication module 704 in communication with the processor module 702 and a first magnetic module in communication with the processor. The system 702 further comprises one or more output devices in communication with the processor module 702. The system further comprises one or more sensors 610 in communication with the processor module 702 and the storage module 706. The system further comprises an actuator module 712 in communication with the processor module 702 and the first magnetic module 1014.

In one embodiment, the processor module 702, the storage module 706, the communication module 704, the first magnetic module 1014, the actuator module 712, output devices 708, one or more sensor 710 are embedded within the respective articulating apparatus 604. In another embodiment, the processor module 702, the storage module 706, the communication module 704, output devices 708, one or more sensor 710 are separately provided from the respective articulating apparatus 604.

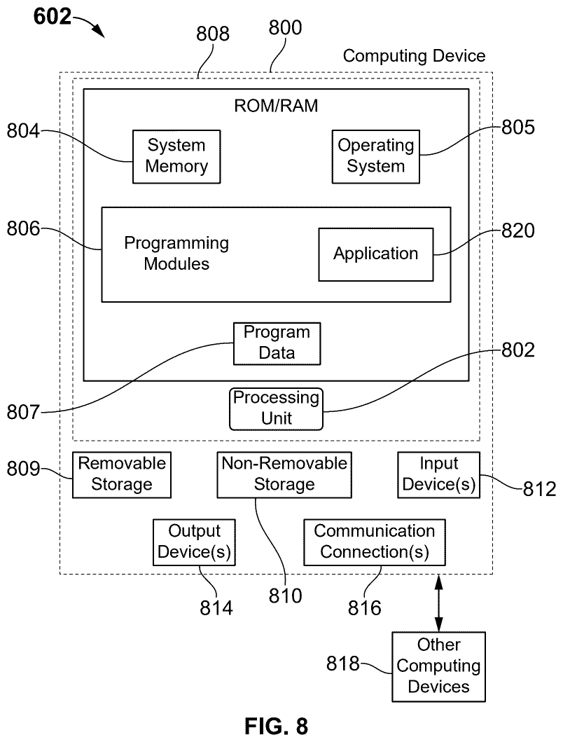

FIG. 8 exemplarily illustrates a computing device 602 of FIG. 6, according to another embodiment of the present invention. The computing device 602 include at least one processing unit 802 and a system memory 804. Depending on the configuration and type of computing device, system memory 804 include, but is not limited to, volatile (e.g. random-access memory (RAM)), non-volatile (e.g. read-only memory (ROM)), flash memory, or any combination. System memory 804 include operating system 1105, one or more programming modules 806, and include a program data 1107. Operating system 1105 suitable for controlling computing device 602's operation. In one embodiment, programming modules 806 include image-processing module, machine learning module and/or image classifying module. Furthermore, embodiments of the disclosure be practiced in conjunction with a graphics library, other operating systems, or any other application program and is not limited to any particular application or system. This basic configuration is illustrated in FIG. 8 by those components within the dashed line 808, 800.

Computing device 602 have additional features or functionality. For example, computing device 602 also include additional data storage devices (removable and/or non-removable) such as, for example, magnetic disks, optical disks, or tape. Such additional storage is illustrated in FIG. 8 by a removable storage 1109 and a non-removable storage 810. Computer storage media include volatile and nonvolatile, removable and non-removable media implemented in any method or technology for storage of information, such as computer-readable instructions, data structures, program modules, or other data. System memory 804, removable storage 1109, and non-removable storage 810 are all computer storage media examples (i.e., memory storage.) Computer storage media include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 602. Any such computer storage media is a part of device 602. Computing device 602 also have input device(s) 812 such as a keyboard, a mouse, a pen, a sound input device, a touch input device, a location sensor, a camera, a biometric sensor, etc. Output device(s) 814 such as a display, speakers, a printer, etc. also included. The aforementioned devices are examples and others may be used.

Computing device 602 also contain a communication connection 816 that allow device 602 to communicate with other computing devices 818, such as over a network in a distributed computing environment, for example, an intranet or the Internet. Communication connection 816 is one example of communication media. Communication media may typically be embodied by computer-readable instructions, data structures, program modules, or other data in a modulated data signal, such as a carrier wave or other transport mechanism, and includes any information delivery media.

The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 804, including operating system 1105. While executing on processing unit 802, programming modules 806 (e.g., application 1120 such as a media player) may perform processes including, for example, one or more stages of methods, algorithms, systems, applications, servers, databases as described above. The aforementioned process is an example, and processing unit 802 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It is further clarified that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable other individuals of ordinary skill in the art to understand the disclosure for various embodiments with various modifications as are suited to the particular use contemplated.

What is claimed is:

1. An articulating system, comprising:
two or more objects, each object comprises one or more bobbling components;
one or more joining modules, at least one joining module connect each bobbling component movably to the respective object;
a magnetic module comprises at least two magnetic components, wherein at least two magnetic components comprise a first magnetic component and a second magnetic component, wherein the first magnetic component is an electromagnet, wherein the first magnetic component is disposed within one bobbling component, wherein the second magnetic component is disposed proximal to the first magnetic component and within at least one of the object respective of the bobbling component associated with the first magnetic component and another bobbling component of another object;
a power source module configured to supply power to the electromagnet, and
a processor module in communication with the power source module, the processor module is configured to control the power source module to supply power to the magnetic module, the power supply to the first magnetic component creates a magnetic field that attracts the second magnetic component, thereby inducing movement to the bobbling components associated with the first and second magnetic components.

2. The system of claim 1, wherein the bobbling component of one object is not attached to the bobbling component of another object, wherein the processor module is configured to induce a brief collision via the magnetic module and enables the bobble component of each object to bobble independently.

3. The system of claim 1, wherein two or more bobbling components of two or more objects are connected together, the two or more bobbling components are connected to at least one bobbling component associated with the magnetic component to enable movement of the connected bobbling components.

4. The system of claim 1, wherein the joining module comprises an elastic member.

5. The system of claim 1, wherein the joining module comprises one or more components selected from a group comprising, one or more magnets, one or more electromagnets, an electromechanical device, a spring, a conical spring, a leaf spring, a compression spring, a torsional spring, a garter spring, a hinge joint, a pivot joint, a prismatic joint and a ball-socket joint.

6. The system of claim 1, wherein the second magnetic component comprises at least one of a ferromagnetic component, permanent magnet, the electromagnet, and a metal component.

7. The system of claim 1, wherein the processor module is configured to control supply of power to the magnetic module such that a first polarity of the first magnetic component is opposite to a second polarity of the second magnetic component, the processor is configured to intermittingly alter the first polarity and the second polarity by the supply of electrical power to generate at least one of a attraction force and a repulsion force between the first magnetic component and the second magnetic component, thereby inducing a sequence of movement to the bobbling components.

8. The system of claim 1, further comprises one or more actuators in communication with the processor module and the magnetic module, the actuator is configured to control the polarity and magnetic field associated with the magnetic components.

9. The system of claim 8, further comprises: a storage module in communication with the processor module, the storage module stores user information comprising one or more characteristics of one or more user, bobble sequence information comprising one or more bobble sequences and one or more bobble sequences for each user, one or more audios, one or more light pattern, and one or more audios and light pattern for each user, the characteristics includes sound data, image data, movement data of the user.

10. The system of claim 9, further comprises one or more sensors in communication with the processor module, the sensor is configured to detect one or more characteristics of a user proximal to the objects, the processor is configured to control the power supply to enable the bobbling components to move in at least one sequence of movement corresponding to the user.

11. The system of claim 10, further comprises one or more output devices in communication with the processor module, the output devices comprise an audio device and a light source device, the processor is configured to control the audio device to emit audio, control the light source device to emit light of one or more wavelengths, control the audio device to emit an audio corresponding to the user proximal to the objects and control the light source device to emit a light pattern corresponding to the user proximal to the objects.

12. The system of claim 11, further comprises a computing device in communication with the storage module, the processor module and the communication module via a network, the computing device comprises a memory storing one or more program modules and a processor configured to execute the program modules, the computing device is configured to control the output device to emit light of one or more wavelengths and emit audio, and control the sequence of movement of the bobbling component.

13. The system of claim 12, wherein the computing device is configured to control the bobbling component to move in a desired sequence of movement, control the audio device to play a desired audio and control the light device to emit a desired light pattern, and control a duration of the sequence of movement of the bobbling component.

14. The system of claim 13, further comprises a user device in communication with the computing device via the network, the computing device is configured to receive one or more input data from the user device to execute the program modules to control the objects.

15. The system of claim 1, wherein the processor module is configured to control a duration of the sequence of movement of the bobbling component.
